(19) United States
(12) Patent Application Publication
(10) Pub. No.: US 2012/0241147 A1
(43) Pub. Date: Sep. 27, 2012

(54) REELABLE SUPPORT

(76) Inventor: Andre Martin Van der Ende, Udny Green (GB)

(21) Appl. No.: 13/505,037

(22) PCT Filed: Oct. 28, 2010
(86) PCT No.: PCT/GB2010/002003

§ 371 Date: Jun. 12, 2012

(30) Foreign Application Priority Data
Oct. 28, 2009 (GB) 0918888.9

(51) Int. Cl. E21B 23/14; B29C 31/00

(52) U.S. Cl. 166/241.5; 264/119

(57) ABSTRACT

A reelable slickline for use in downhole or subsea operations has a structural core comprising a plurality of non-metallic fibres in a matrix. The fibres represent in the region of 30 to 50% of the volume of the core.

### FIELD OF THE INVENTION

This invention relates to reelable support members for use in downhole operations, and also to methods of making such supports. In particular, the invention relates to a support comprising a composite of fibres and a matrix.

### BACKGROUND OF THE INVENTION

In the oil and gas exploration and production industry, wide use is made of reelable support members, such as slickline and wireline, to run devices and tools into oil wells. Slickline tends to be relatively small diameter solid wire, while wireline typically comprises braided wires. Wireline may include signal-carrying elements such as electrical conductors or optical fibres.

There have been numerous proposals for slickline or wireline including non-metallic elements. However, the great majority of slickline and wireline is still primarily metallic.

### SUMMARY OF THE INVENTION

According to the present invention there is provided a reelable support member for use in downhole operations, the member having a structural core comprising a plurality of non-metallic fibres in a matrix, wherein the fibres represent in the region of 30 to 50% of the volume of the core.

The invention also relates to a method of producing a reelable support member, the method comprising:

providing a plurality of non-metallic fibres;

providing a settable material;

combining the fibres and the settable material; and

setting the material to form a core, whereby the fibres represent in the region of 30 to 50% of the volume of the core.

The fibres may represent 35 to 45% of the volume of the core. In one embodiment the fibres may represent 40% of the volume of the core.

The member or core may consist essentially of non-metallic material, however the core may include one or more small diameter metallic signal carrying-members, and in some embodiments metallic or carbon-based materials may be incorporated in a cover or sheath to provide anti-static properties.

The core may have a substantially homogenous structure of fibres and settable material. The fibres and settable material may be distributed substantially constantly across the cross-section of the core.

The fibres may be very fine, having a linear density, or weight per unit length of approximately 1000 dtex (1 dtex=1 g/10,000 m). The fibres may have a density of 1.5 to 2.5 g/cc, and a linear density in the range of 250 to 2500 dtex. The use of relatively fine fibres enhances the flexibility of the member.

The fibres may comprise monofilaments.

The fibres may comprise any suitable material, such as a para-aramid, a meta-aramid, glass, PBO, liquid crystal polymer (LCP) and carbon, such as the fibres sold under the trademarks Kevlar, Zylon, 12k Thornel, Twaron and E-glass.

The member may comprise 65,000 filaments. The number of filaments may be in the range of 13,000 to 250,000.

The core may have a linear weight of 20 g/m, and the linear weight may be in the range of 15 to 60 g/m. The core may have a density in the range of 1.40 to 1.45 g/cc.

The member may include a sleeve or coating around the core. The coating may provide abrasion resistance for the member, protecting the fibres on the surface of the core from damage. The coating may be visually distinguishable from the core, for example the coating may be a different colour from the core, to facilitate identification of wear of the coating. The coating may be compatible with the matrix, and may be the same or a similar material to the matrix. The coating may comprise materials selected to enhance tribological or electrostatic dissipative properties, for example the coating may comprise one or more of graphite, short para/meta-aramid fiber, CNFs, TiC and ceramics.

The core may have a circular cross-section and a cylindrical outer surface. Alternatively, the core may have a non-cylindrical surface. The provision of a non-cylindrical surface may facilitate adherence of a coating or sheath on the core.

The member may have a cylindrical surface. This facilitates use of the member in conjunction with stuffing box seals and the like.

The matrix may be compliant or elastomeric, facilitating distribution of load between the fibres.

The matrix may comprise a thermoplastic material, such as PEEK. The use of thermoplastic material, having a degree of resilience, tends to improve the bend radius of the member, facilitating use of the member with apparatus and methods originally intended for use with relatively flexible metallic members such as conventional slickline and wireline. The matrix material may comprise an elastomer, for example a perfluoroelastomeric material such as sold under the Kalrez trademark. In other embodiments the matrix may be a thermosetting material, LCP or Polyamide 46 (Stanyl).

The member may have a diameter up to 12 mm. In one embodiment the member has a diameter of 5 mm, the core having a diameter of 4.5 mm and a 0.25 mm thick coating.

At least some of the fibres may be continuous or long fibres. The fibres may be the same or similar length as the member.

At least some of the fibres may extend solely longitudinally, that is parallel to the member axis with little or no twisting or weaving. Thus, when in tension the fibres will not tend to cut across other fibres.

The core may include one or more signal, power or fluid transfer members, such as optical fibres, electrical conductors, or gas or hydraulic lines. The fibres, conductors or lines may be coated with a release agent or other material to facilitate separation of the matrix and other fibres from the optical fibres or conductors. Alternatively, the optical fibres, electrical conductors or gas/hydraulic lines may be located within a separate tube of a metallic or non-metallic material.

The settable material may be initially provided in the form of a powder. The particle size of the powder may be of similar order of magnitude to the fibre diameter. For example, 12 micron diameter fibres may be combined with 40 micron diameter particles, the particle size typically ranging from 10 to 50 micron.

The settable material may take any other appropriate form, for example the material may be initially applied to the fibres in liquid form. Alternatively, at least some of the fibres may be provided with a coating of suitable material, or the settable material may be provided in the form of fibres which are combined with the non-metallic fibres and then melted.

The core may be drawn through one or more dies to compact the core. Some or all of the one of more dies may be heated. Some or all of the dies may be placed in an inert medium, for example, an inert gas atmosphere such as an over-pressurised enclosure containing an inert gas atmosphere. In at least one of the embodiments, the inert gas atmosphere may comprise one or more inert gases. The dies may be static or roll-forming.

The fibres may be provided with sizing to facilitate coating of the fibres with the settable material.

One or more of the fibres and the settable material may be electrically charged prior to combining the fibres and settable material. The fibres and the settable material may be provided with opposite charges. The charges may be applied or created by any appropriate method. In one embodiment a static charge is applied to the fibres by passing the fibres over a corona wire, which may apply a negative charge to the fibres. The charge may be in the region of 0 to 100,000 kV. The settable material may be initially provided in particulate or powder form. The particles may be oppositely charged relative to the fibres. The fibres may be combined with the settable material at least in part using tribostatic powder coating, in which the particles of settable material are passed through a tribo gun. The particles may be positively charged.

The fibres may be under tension when combined with the settable material. The tension may be relaxed or reduced to facilitate separation of the fibres and facilitate intermingling of the fibres and the settable material. Alternatively, or in addition, a static charge may be applied to the fibres in the relaxed state to separate the fibres. Some fibres, such as carbon fibres, will not hold static charges and such fibres may be separated by other mechanisms, such as passing the fibre bundle over a curved surface, such as a dome or a geodesic roller, or by utilising a pneumatic spreader.

The settable material may be heat settable. The combined fibres and settable material may be pre-heated before being passed through one or more heated dies. The dies may be arranged to soften or melt the settable material and remove air and surplus settable material from within the core. The dies may define progressively smaller openings. On cooling, the settable material may solidify to form the matrix.

One or more of the dies may be provided with load sensors to provide control feedback. For example, and increase in load experienced by a die may indicate that the volume of settable material being applied to the fibres should be decreased, or the rate of progress of the fibres through the dies should be reduced.

A coating may be extruded or otherwise formed over the core.

The core may be subject to heating and cooling before or after the application of the coating.

The member is adapted to withstand conditions likely to be experienced downhole, including elevated temperatures and pressures, having a maximum continuous temperature rating of 250 degrees C. The member is also adapted to accommodate being stored on a reel and passed around relatively small diameter sheaves while under load, typically having a minimum bend radius of 250 mm. A 5 mm diameter member may have a minimum breaking load of 3,000 kg, a weight of 25 g/m, and a stretch of 2-3%.

In addition to having utility as reelable support member for use in downhole operations, embodiments of the invention may also be useful in subsea operations, including deep water applications, solely as a support member or additionally comprising embedded power, signal or fluid carrying lines or members. Embodiments of the invention may thus serve as umbilicals which also serve as supports. Such embodiments of the invention are likely to be of larger diameter than the downhole supports.

### BRIEF DESCRIPTION OF THE DRAWINGS

These and other aspects of the present invention will now be described, by way of example, with reference to the accompanying drawings, in which:

FIG. 1 is a sectional view of a reelable support member in accordance with an embodiment of the present invention;

FIG. 2 is an enlarged view of a portion of the core of the member of FIG. 1; and

FIG. 3 is a schematic illustration of the production of the reelable support member of FIG. 1.

### DETAILED DESCRIPTION OF THE DRAWINGS

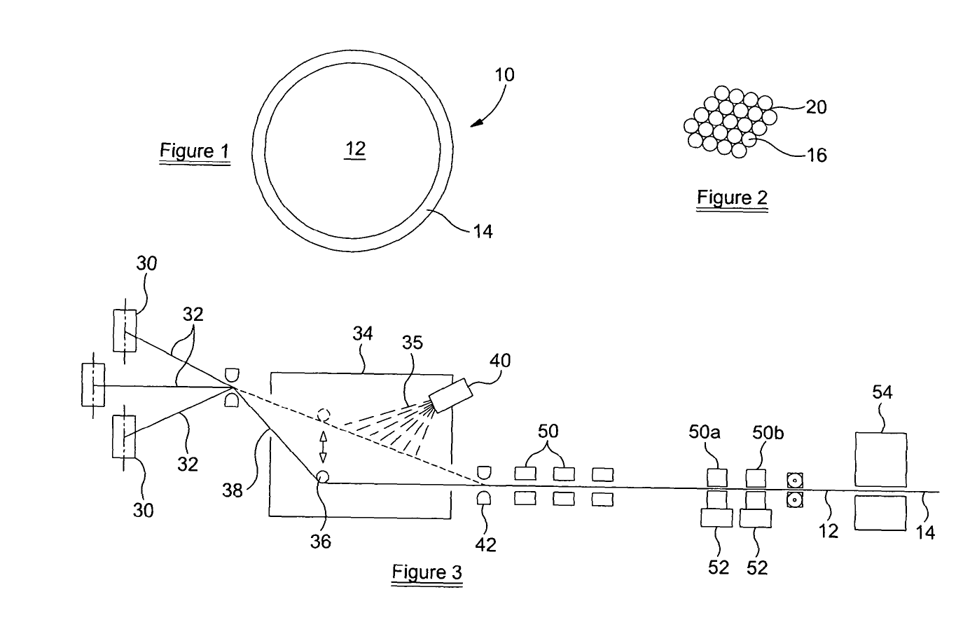

Reference is first made to FIGS. 1 and 2 of the drawings, FIG. 1 being a sectional view of a reelable support member 10 in accordance with an embodiment of the present invention, and FIG. 2 an enlarged view of a portion of the core of the member 10 of FIG. 1. The member 10 has an external diameter of 5 mm and may be of any length. Typically, the member 10 will be several thousand meters long. The member 10 is circular in cross-section and comprises a structural core 12 and an abrasion-resistant external sleeve 14.

The core 12 has a diameter of 4.5 mm and comprises a large number of very fine long fibres or filaments 16 of equal length to the member 10. In this embodiment, the core 12 comprises approximately 65,000 filaments, each filament 16 having a diameter of approximately 12 microns and a linear density of approximately 1000 dtex. The filaments are arranged in the core substantially longitudinally, without twisting, braiding, weaving or the like. Thus, when load is applied to the core 12 there is little or no tendency for the filaments to tend to straighten and potentially cut into one another.

The filaments 16 are formed of para-aramid, such as sold under the Kevlar trade mark and are set in a matrix 20 of a thermoplastic material, in this embodiment a matrix of polyetheretherketone (PEEK). The filaments 16 are generally circular in cross-section and the thermoplastic material occupies the spaces between the fibres 16, such that in cross-section the core is substantially homogenous and the fibres are substantially equally spaced though the core. In this embodiment the fibres 16 represent 40% of the volume of the core 12, and the thermoplastic material the remaining 60%. The selected materials and proportions of fibre and thermoplastic material in the core 12 results in a member 10 with a high strength/weight and high strength/volume ratios. Of course this offers many advantages, minimising the size and weight of a reel comprising a long length of member 10, and minimising the self-weight of the member 10, which otherwise reduces the load which may be supported on a long member. Furthermore, this combination of materials provides a member 10 with excellent handling properties, such that the member 10 may be readily reeled and will pass over sheaves and through measuring heads and the like originally developed and designed for use with metallic slickline, wireline and the like. The member 10 is also resistant to fatigue failure and separation of the filaments on the core.

The sleeve 14 is formed of a material which is compatible to the matrix-forming material, and in this embodiment the sleeve 14 is also formed of PEEK with anti-static additives, such as metallic or graphite fillers. The sleeve is 0.25 mm thick.

An example of a method of producing the member 10 will now be described with reference to FIG. 3 of the drawings.

The filaments 16 are initially provided on ninety packages or bobbins 30. Each package 30 carries a yarn 32 comprising approximately 725 filaments. The yarns are pulled from the packages 30 under light tension and gathered together before being passed through a chamber 34 where the matrix-forming material 35, in fine powder form, is applied to the yarn bundle 38.

The bundle 38 passes down through the chamber 34 at an angle and pass under a corona wire 36 which applies a negative static charge of 100,000 kV to the filaments 16.

The matrix-forming material 35 is sprayed down and onto the filaments after the yarn bundle 38 has passed over the corona wire 36. To facilitate adherence of the particles to the filaments the particles are passed through a tribo gun 40, which applies a positive static charge to the particles.

Furthermore, the corona wire 36 is arranged to reciprocate vertically, to vary the tension experienced by the filament bundle. In particular, in the arrangement shown, as the wire 36 moves upwards the tension in the bundle 38 is reduced, allowing the momentarily relaxed filaments to move apart under the influence of the static charge applied to the filaments by the corona wire 36. Also, the spray of powder from the tribo gun 40 tends to separate the filaments 16. This ensures that particles achieve a high degree of coverage of the filaments 16.

The particle-coated filaments are then drawn over a heated bar 42 which heats the bundle and causes an initial degree of softening of the particles and causes the particles to adhere to the filaments.

The pre-heated particle-coated filaments are then passed through a series of heated static and roll-forming dies 50 which serve to soften and melt the matrix-forming material particles while progressively compacting the bundle 38 to expel air and any excess matrix-forming material. In the illustrated embodiment ten dies 50 are provided, the die surfaces being heated to 350-450° C.

The last three static dies (two illustrated) 50a, 50b include load sensors 52 which indicate the load being applied to the dies by the core passing through the dies. An increase in the load applied to the dies may be indicative of, for example, a higher loading of settable material, increasing the resistance to passage of the core through the dies.

The final die is an unheated roll-forming die 50c, which permits a degree of cooling and relaxation of the core. Also, the final die 50c provides a degree of control, being set to the desired final core diameter, in this example 4.5 mm. If the die is not in contact with the core surface this indicates that the core contains less settable material than desired.

The compacted core 12 is formed of continuous solid material and thus does not contain any gas pockets or bubbles and will therefore be resistant to gas migration through the core and to explosive decompression.

The core 12 is next passed through an extrusion die where a 0.25 mm thick coating 14 of PEEK is applied to the core 12. To provide the member 10 with desirable anti-static properties the PEEK contains conductive particles, such as graphite of metallic powder.

The coating is then allowed to cool and the member 10 gathered on a driven storage reel (not shown).

The core of the embodiment described above consists of only non-metallic structural filaments and the settable material. However, in other embodiments the core may include one or more optical fibres or one or more electrical signal carriers. These additional fibres may be incorporated in the core, preferably being located centrally within the core. The additional fibres may incorporate a release agent coating, which facilitates separation of the settable material from the fibres to provide access to the fibres.

An electrical signal carrier may be configured to provide transmission of electrical power from surface to a tool or device mounted on the distal end of the member. A relatively fine carrier of a material such as copper may permit trickle-charging of a battery or cell provided in the tool or device.

What is claimed is:

1. A reelable support member for use in downhole operations, the member having a structural core comprising a plurality of non-metallic fibres in a matrix, wherein the fibres represent in the region of 30 to 50% of the volume of the core.

2.-47. (canceled)

48. A reelable support member for use in subsea operations, the member having a structural core comprising a plurality of non-metallic fibres in a matrix, wherein the fibres represent in the region of 30 to 50% of the volume of the core and wherein the core includes at least one of an optical fibre, electrical conductor, or gas or hydraulic lines.

49. A method of producing a reelable support member, the method comprising: providing a plurality of non-metallic fibres; providing a settable material; combining the fibres and the settable material; and setting the material to form a core, whereby the fibres represent in the region of 30 to 50% of the volume of the core.

50.-110. (canceled)
